(19) United States
(12) Patent Application Publication
(10) Pub. No.: US 2013/0260725 A1
(43) Pub. Date: Oct. 3, 2013

(54) System And Method For Elective Call Termination To A Mobile Unit In A Moving Vehicle

(71) Applicant: Ranjan Sharma, New Albany, OH (US)

(72) Inventor: Ranjan Sharma, New Albany, OH (US)

(21) Appl. No.: 13/434,926

(22) Filed: Mar. 30, 2012

(51) Int. Cl. H04W 4/00

(52) U.S. Cl. 455/414.1

(57) ABSTRACT

A method for performing elective call termination to a mobile unit is provided. A call request is received a mobile unit. If the mobile unit is in a vehicle and traveling at a speed greater than a speed threshold and is driving the car, selective call termination is provided. The call request is screened by playing an announcement to the caller that the intended call recipient is a mobile phone that is currently being used by the driver of a cat travelling at a speed greater than a speed threshold. The caller can then decide if the call is important enough to distract the driver, which could be the case, for example, in an emergency situation.

### FIELD OF THE INVENTION

The present invention relates generally to communication systems, and more particularly to mobile devices that are being used in a vehicle.

### BACKGROUND OF THE INVENTION

One cause of vehicular accidents is driver distraction caused by an incoming call to the driver's mobile phone. In fact, incoming calls can be more deleterious to highway safety than outgoing calls because the driver is placing the outgoing calls and is therefore prepared for the distraction, whereas incoming calls are a surprise to the call recipient and therefore more distracting.

Some jurisdictions have passed laws to restrict the use of cell phones while driving. Unfortunately, these laws are oftentimes not obeyed. Further, there are times when a caller needs to get a hold of a driver of a vehicle, for example during an emergency situation.

Callers often do not know what the called party is doing at the time they place a call to the called party. This can lead to potentially dangerous situations if the call is being placed to the driver of a vehicle.

A restriction could be placed so that if a mobile phone is in a moving car it is temporarily disabled, so that the mobile unit cannot receive or place any calls. One problem with this idea is that it prevents all car riders from utilizing their mobile phones, even if they are not driving. This can be incredibly inconvenient.

Therefore, a need exists for a way of increasing traffic safety, in particular when calls are placed to drivers of moving vehicles.

### BRIEF SUMMARY OF THE INVENTION

An exemplary embodiment of the present invention relates to a method, vehicle, and steering wheel for performing elective call termination to a mobile unit in a moving vehicle.

An exemplary embodiment provides a solution for the aforementioned problems. When a call is placed to a mobile unit, the wireless network of the mobile unit determines if the mobile unit is currently moving, for example by being located in a vehicle.

If the mobile unit is moving at a speed greater than a predetermined speed threshold, a determination is made as to whether the user of the mobile unit is the driver. If the user is not currently driving then any calls to that mobile unit will be connected as normal.

If the user of the called mobile unit is driving, additional processing in accordance with an exemplary embodiment is performed. The determination as to whether the user of the mobile unit is the driver is preferably done by defining a driver zone in the passenger compartment of the vehicle. This is preferably done by including a near field communication (NFC) transceiver in the steering wheel of the vehicle. If the mobile unit is located within a predetermined distance from the NFC transceiver, then a determination is made that the user of the mobile unit is currently driving the car.

If the car is moving faster than the predetermined speed threshold and the user of the called phone is driving, the call request is intercepted and call screening occurs. This entails playing an announcement to the caller to alert the caller that the called mobile unit is being used by a user who is currently driving a moving vehicle. The caller is then presented with an option of whether they would like to continue trying to complete the call or choose an alternate option. The caller may want to complete the call request due to a perceived emergency that they are involved in.

If the caller decides to not complete the call request, several options are preferably presented to the caller. The caller can hang up and try to call later, be placed on hold until either the vehicle slows to below the predetermined speed threshold or the user moves the phone out of the driver zone, leave a voice mail message for the mobile unit, be called back by the mobile unit, or send a text message to the mobile unit.

### BRIEF DESCRIPTION OF THE SEVERAL VIEWS OF THE DRAWINGS

FIG. 1 depict a system including a wireless network in accordance with an exemplary embodiment of the present invention.

FIG. 2 depicts a top view of a vehicle in accordance with an exemplary embodiment of the present invention.

FIG. 3 depicts a flowchart in accordance with an exemplary embodiment of the present invention.

### DETAILED DESCRIPTION OF THE INVENTION

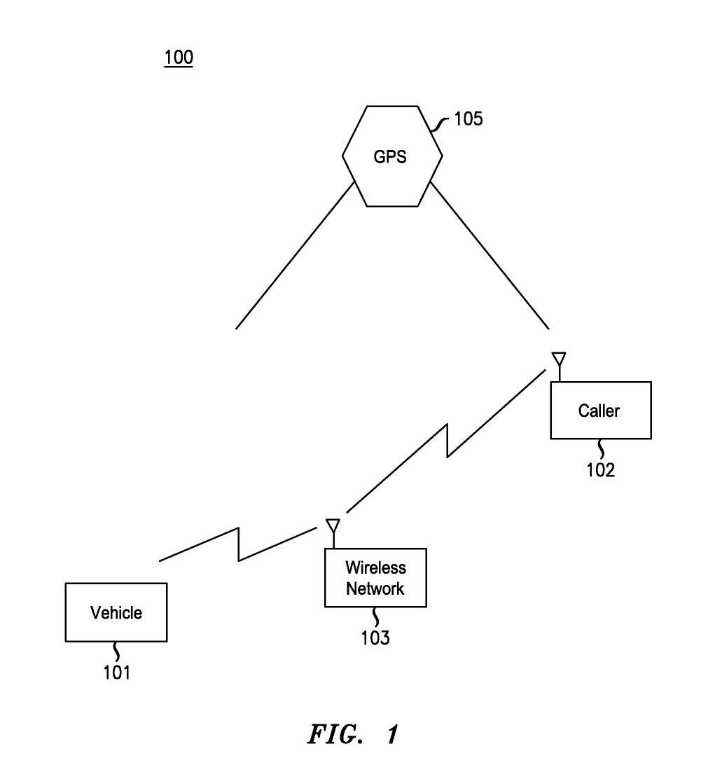

An exemplary embodiment of the present invention can be better understood with reference to FIGS. 1 through 3. FIG. 1 depicts a system 100 including a vehicle 101, a caller 102, a wireless network 103, and a Global Positioning System (GPS) 105.

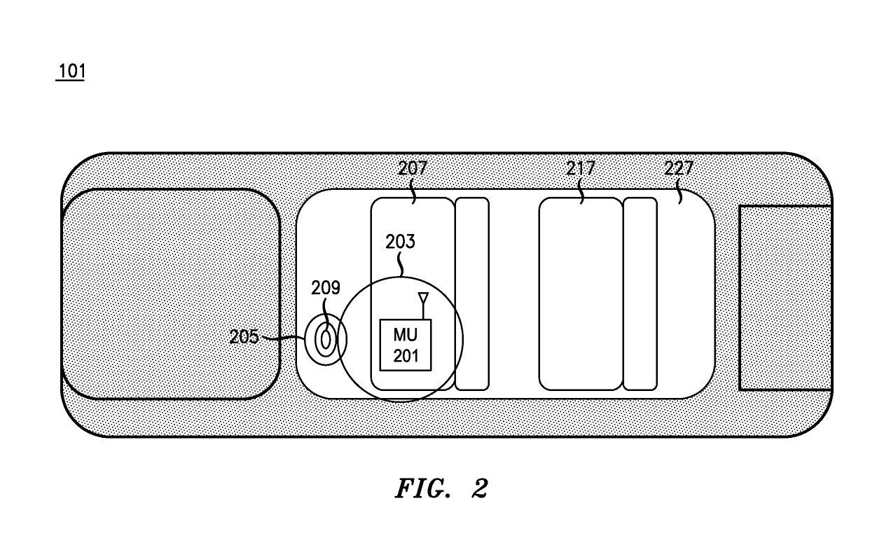

Vehicle 101 is a car, truck, van, or the like. Vehicle 101 is depicted in greater detail in FIG. 2. Vehicle 101 is preferably a device that is designed or used to transport people or cargo, such as a car, van, or minivan.

Caller 102 is a telecommunications device that is capable of making calls to other telecommunications units. Caller 102 can be a mobile unit, a wireline communication unit, or any other communication device that is capable of making calls within system 100. Although depicted as a mobile phone in FIG. 1, it should be understood that caller 102 is not limited to mobile units.

Wireless network 103 is a wireless telecommunications network that comprises a plurality of base stations and other network elements that allow wireless network 103 to process wireless communications. Wireless network 103 communicates with mobile unit 201 via any of a plurality of air interfaces. Wireless network 103 is, for example, a CDMA (Code Division Multiple Access) or GSM (Global System for Mobile Communications) system.

GPS 105 is a positioning system. In an exemplary embodiment, GPS 105 is a space-based satellite navigation system that provides location and time information in all weather, anywhere on or near the Earth, where there is an unobstructed line of sight to four or more GPS satellites. GPS 105 is preferably the system maintained by the United States government and freely accessible by anyone with a GPS receiver.

FIG. 2 depicts a top view of vehicle 101 in accordance with an exemplary embodiment of the present invention.

Vehicles 101 comprises a passenger compartment 227. Passenger compartment 227 comprises a steering wheel 205, a front seat 207, and a back seat 217. It should be understood that passenger compartment 227 can have many alternative arrangements, including additional rows of seats, bucket style seats instead of bench style seats, and many other configurations.

Steering wheel 205 is utilized to control vehicle 101 while driving. In accordance with an exemplary embodiment of the present invention, steering wheel 205 comprises a near field communication (NFC) transmitter 209.

NFC is a set of standards for smartphones and similar devices to establish radio communication with each other by bringing them into close proximity. Current NFC standards cover communications protocols and data exchange formats, and are preferably based on existing radio-frequency identification (RFID) standards including ISO/IEC 14443 and FeliCa. The standards include ISO/IEC 18092 and those defined by the NFC Forum.

NFC transceiver 209 defines driver zone 203. In accordance with an exemplary embodiment, calls made to mobile phones located within driver zone 203 when vehicle 101 is moving faster than a predetermined speed threshold are intercepted and the caller is prompted to make sure that the caller still wants to complete the call in spite of the called party being the driver of a moving vehicle.

A driver sits nearest to steering wheel 205 inside vehicle 101. The passengers, if any, are farther removed from steering wheel 205. In accordance with an exemplary embodiment, NFC transceiver 209 embedded in steering wheel 205 is used to “color” the driver's phone differently to wireless network 103. NFC offers the distinct advantage over comparable technologies, like Bluetooth (BT), in that the NFC range is shorter than a typical BT device. So, if there are passengers in vehicle 101, their devices remain normally operative, unless borrowed by the vehicle's driver.

In accordance with an exemplary embodiment, a passenger in vehicle 101 has a mobile unit 201. Mobile unit 201 is a mobile device that communicates with wireless network 103, preferably using a wireless air interface.

An exemplary embodiment of the present invention comprises a system and method that determines if, upon receiving a call request intended for mobile unit 201, vehicle 101 is traveling faster than a predetermined threshold. If so, the system determines if mobile unit 201 is located within driver zone 203. If so, the system knows that the called party is the driver of a moving vehicle.

Since distracting a driver of a moving vehicle can lead to a dangerous situation, the system intercepts the call request and alerts the caller that the called party is currently driving a moving vehicle.

At this point, the system gives the caller the ability to decide if they still want to complete the call, knowing that the recipient of the call request is driving a vehicle. The caller may decide that this call is important or urgent enough to complete, for example if there is an emergency situation that they want to tell the called party about.

If the caller decides not to complete the call request, the system can either end the call request, send a text message to the called party, place the caller into the voice mail of the called party, place the caller in a hold state until the vehicle stops or the called party is no longer driving, or into a special queue that will complete the contact the called party when certain conditions are met and then alerting the calling party.

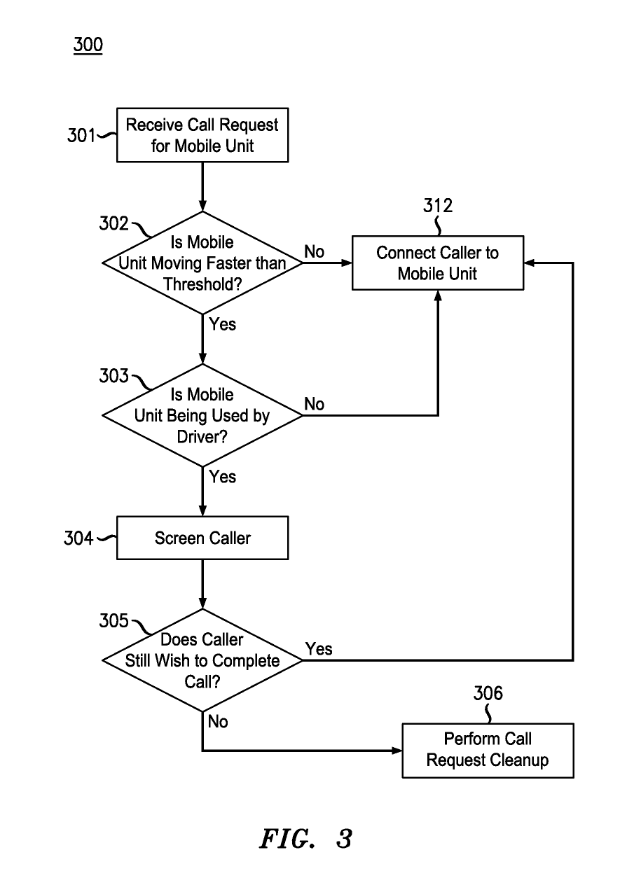

FIG. 3 depicts a flowchart 300 a method of elective call termination to a mobile unit 201 in a moving vehicle 101 in accordance with an exemplary embodiment of the present invention.

Elective call termination is preferably a subscription-based service. In this embodiment, trigger points are associated with subscribing mobile units in each mobile unit's HLR profile. In an alternate exemplary embodiment, elective call termination is applied to all subscribers.

In a first exemplary embodiment, the association of triggers is static, as in the case of provisioning the HLR. In an alternate exemplary embodiment, the triggers are armed dynamically. The advantage to this embodiment is that only moving mobile phones identified as a vehicle driver's phone would be subjected to extra processing.

In accordance with an exemplary embodiment, wireless network 103 receives (301) a call request for mobile unit 201. The calling party dials the number of mobile unit 201. The call request is routed by wireless network 103 to the Home MSC, which is the O-MSC in ANSI, of mobile unit 201. The MSC, in conjunction with the HLR, determines that special screening has to be provided for calls to mobile unit 201. The MSC preferably sends an ISUP Initial Address Message (IAM) to a service node (SN) hosting the service. In an exemplary embodiment, in the IAM, the CgPN parameter is set to the Calling Party's Directory Number, the Redirecting Number parameter is set to the called party's MDN, and the CdPN parameter is set to the routing digits that are used to route the call to the SN.

The SN recognizes that the call is meant for a subscriber who has the intercept service turned on currently. The SN routes the call instance to the intercept service that it hosts. The intercept service responds with an ISUP Address Complete Message (ACM), so that a voice path cut-thru to the calling party occurs.

As the driver moves through the mobile coverage area, the mobile device attaches to a BTS for a specific cell. Existing hand-off techniques ensure that the subscriber gets continued coverage as the vehicle moves through an area which is served by the mobile network. Communication between the BTS and the mobile device carries the information that the phone belongs to the driver of a moving vehicle, for example via the LAPD frame's information part. In order to achieve this, NFC chip 209 embedded in steering wheel 205 is employed. NFC chip 209 interacts with mobile unit 201 phone and “colors” the LAPD frame to indicate to the network that call termination restrictions should be in force.

A frame is preferably “colored” to indicate to wireless network 103 that the call termination to mobile unit 201 should be elective. In a first exemplary embodiment, the LAPD protocol extends the Control field. Currently, the control field is typically one byte, but can alternately be two bytes. The control field conveys information about whether the receiver is ready or not, if a rejection has resulted, or whether some information is being carried. In this embodiment. the control field is extended to carry a bit-string that indicates to the BTS that the mobile device should be subjected to special handling via the elective call completion service. As one example, the unnumbered format (U-Format) Control Field is utilized. When the U-Format Control field carries a predefined bit string, such as the bit string “000P0111”, it indicates “coloring”, which implies following restrictions when the network attempts to terminate a call to this device. The choice of the bit string is dictated by strings already in use for existing purposes. However, other representations are also possible as long as these bit strings are not already in use for some other purpose.

In a further exemplary embodiment, the Information Format (I-Format) Control field, which can carry three octets, is utilized. In one exemplary embodiment, the seven MSBits in each octet are used to represent “D”, “R” and “V” in 7-bit ASCII format, where “DRV” signifies that the phone belongs to the driver of the vehicle. It should be clear that any equivalent bit-string can be employed to signify this, and “DRV” by no means is the only possible representation for this.

In either case, we assume that the BTS communicates with the BSS and then with the MSC and appropriate flags are set in the HLR to indicate that the mobile device in question may be under restrictions.

Wireless network 103 determines (302) if mobile unit 201 is moving faster than a threshold value. If not, wireless network 103 connects (312) the caller to mobile unit 201, thereby terminating the call request. The threshold value is preferably set to a value at which being interrupted would distract a driver. In a first exemplary embodiment, the threshold value is set to zero, so that if the car is moving at all than the threshold is exceeded. This value can be set to other values, and can include other factors, including how long a driver has been traveling at a particular speed.

In an exemplary embodiment, vehicular movement can be ascertained with the aid of Assisted-GPS, which is common in cellular networks. In a further exemplary embodiment, NFC transceiver 209 on vehicle 101 can be integrated with the computer system in vehicle 101 to obtain speed information of vehicle 101. This speed information can be transmitted to mobile unit 201. In this exemplary embodiment, when the vehicle is moving at a speed above the pre-determined threshold, the LAPD protocol is appropriately “colored” to provide this information to the network. In a further exemplary embodiment, middleware installed on mobile unit 201 is enhanced to take successive location probes at fixed intervals to determine the vehicular speed.

If mobile unit 201 is moving faster than the threshold value as determined at step 302, wireless network 103 determines (303) if mobile unit 201 is being used by the driver of the moving vehicle. If not, wireless network 103 connects (312) the caller to mobile unit 201, thereby terminating the call request.

If mobile unit 201 is being used by the driver of vehicle as determined at step 303, wireless network 103 screens (304) the caller. In an exemplary embodiment, this is done by playing an announcement to the caller and determining an appropriate course of action based upon a response from the caller. The announcement alerts the caller that the requested mobile unit is currently being used by a driver of vehicle that is currently moving at a speed above a predetermined speed threshold.

In an exemplary embodiment, screening occurs in the following manner. The screening process preferably invokes a “Prompt & Collect” operation, which plays a pre-recorded message to the calling party. For example, the message could say something like “The person you are calling is currently driving a vehicle. It is recommended that you call back later. If this is an emergency, you can press 1 to connect to the called party, or simply hang up and call later.” The Prompt & Collect function then waits for a predetermined time, such as five seconds, to collect the DTMF pressed by the calling party on the bearer channel.

The announcement can also include other important information, such as the speed of the vehicle, how long the vehicle has been traveling above the speed threshold, or the location of the vehicle. This information can help the caller determine whether to complete the call request.

The network then queries the caller to determine (305) if the caller still wishes to complete the call. The caller may be calling mobile unit 201 in an emergency situation so may want to complete the call whether or not the user of mobile unit 201 is driving a vehicle. The querying and receipt of a response from the caller can be in the form of digits entered on a keypad, voice response, or any other suitable method of collecting input from the caller.

If the collected DTMF tone is other than 1, as an example, which indicates that the calling party heeds the security warning and does not wish to proceed with the call setup, the SN sends an ISUP REL (release) message towards the MSC to tear-down the call. In response, the MSC sends an ISUP RLC (release complete) message and the interaction finishes.

If the collected DTMF tone is 1, which indicates that the calling party wants to override the security warning played by the intercept service, the SN extends the call leg to the original called party (B-Party), mobile unit 201.

The SN initiates a call towards mobile unit 201 (the B-Party) via initiating an ISUP IAM, that goes to the MSC. In this IAM, the CgPN parameter is set to the Calling Party's Directory Number, the CdPN parameter is set to the MDN of mobile unit 201, and the Redirecting Number parameter is set to SN's routing digits. This ensures that the B-party's mobile phone can correctly display the incoming call from the A-party.

If the caller still wishes to complete the call as determined at step 305, wireless network 103 connects (312) the caller to mobile unit 201, thereby terminating the call request.

If the caller does not wish to complete the call as determined at step 305, wireless network 103 preferably performs (306) call request cleanup. For example, all resources needed to establish the call are released.

In an alternate exemplary embodiment, wireless network 103 presents a series of options to the caller when the driver is moving faster than the predetermined threshold. These include, for example, placing the caller on hold until the called party either passes the phone to someone who is not driving or the vehicle drops below the speed threshold. Wireless network 103 can alternately store the directory number of the calling phone and connect the called mobile unit to the called phone when the called party has either dropped below the predetermined speed threshold or given the phone to someone not driving the vehicle. This could be done automatically or could be done after the called party is prompted and given a choice whether to call back the calling party.

Still further, wireless network 103 may send a text message to mobile unit 201 alerting mobile unit 201 that a calling party is either on hold or has called. The text message preferably includes the caller id information of the calling party.

Alternately, wireless network 103 can place the calling party directly into the voicemail associated with mobile unit 103 whenever a call is received for mobile unit 103 and mobile unit is currently driving a vehicle that is travelling at a speed faster than the predetermined threshold.

When mobile unit 103 moves outside of driver zone 203 or vehicle 101 drops below the predetermined seed threshold, parameters within wireless network 103 are changed to indicate that mobile unit 103 is no longer subject to additional call processing relating to elective call termination. For example, this can occur by having the middleware of mobile unit 103 communicate with the BTS providing coverage and send in the LAPD U-Format control field carrying a predetermined string, such as the UI being set to “000P 1011”.

While this invention has been described in terms of certain examples thereof, it is not intended that it be limited to the above description, but rather only to the extent set forth in the claims that follow.

I claim:

1. A method for performing elective call termination to a mobile unit, comprising:
receiving a call request for a mobile unit;
determining that the mobile unit is in a vehicle that is traveling at a speed greater than a speed threshold;
determining that the mobile unit is being used by the driver of the vehicle; and
screening the call request.

2. A method for performing elective call termination in accordance with claim 1, wherein the step of determining that the mobile unit is in a vehicle that is traveling at a speed greater than a speed threshold comprises determining the speed utilizing GPS.

3. A method for performing elective call termination in accordance with claim 1, wherein the step of determining that the mobile unit is in a vehicle that is traveling at a speed greater than a speed threshold comprises determining the speed utilizing Assisted-GPS.

4. A method for performing elective call termination in accordance with claim 1, wherein the step of determining that the mobile unit is in a vehicle that is traveling at a speed greater than a speed threshold comprises determining the speed utilizing a computer system located in the vehicle.

5. A method for performing elective call termination in accordance with claim 4, the method further comprising the step of, prior to screening the call request, coloring a protocol to transmit the speed to a wireless network.

6. A method for performing elective call termination in accordance with claim 1, wherein the step of determining that the mobile unit is in a vehicle that is traveling at a speed greater than a speed threshold comprises taking successive location probes at fixed intervals in the mobile unit.

7. A method for performing elective call termination in accordance with claim 1, wherein the step of determining that the mobile unit is being used by the driver of the vehicle comprises utilizing a Near Field Communication (NFC) transceiver.

8. A method for performing elective call termination in accordance with claim 1, wherein the step of screening the call request comprises alerting the caller that the mobile unit is in a vehicle that is traveling at a speed greater than the speed threshold.

9. A method for performing elective call termination in accordance with claim 8, wherein the alert includes the speed of the vehicle.

10. A method for performing elective call termination in accordance with claim 9, wherein the alert includes how long the vehicle has been travelling at a speed greater than the speed threshold.

11. A method for performing elective call termination in accordance with claim 8, wherein the alert includes the location of the vehicle.

12. A method for performing elective call termination in accordance with claim 1, the method further comprising the step of routing the caller to a voice mailbox associated with the mobile unit.

13. A method for performing elective call termination in accordance with claim 1, wherein the speed threshold is set to zero miles per hour.

14. A vehicle comprising:
a passenger compartment;
a steering wheel including a near field communication (NFC) transceiver, the NFC transceiver defining a driver zone within the passenger compartment; and
wherein a mobile phone is not operable within the driving zone.

15. A vehicle in accordance with claim 14, the vehicle further comprising speed detection, and wherein the mobile phone is not operable within the driving zone when the speed is greater than a predetermined threshold.

16. A steering wheel comprising a near field communication (NFC) transceiver that defines a driver zone, and wherein a cell phone is not able to receive calls when located within the driver zone.
